(19) United States
(12) Patent Application Publication
(10) Pub. No.: US 2001/0044296 A1
(43) Pub. Date: Nov. 22, 2001

(54) METHOD FOR AUTHENTICATING AN OVER-THE-AIR FUNCTIONAL ENTITY TO A WIRELESS TERMINAL

(76) Inventor: SEMYON BOROH MIZIKOVSKY, MONMOUTH COUNTY, NJ (US)

Correspondence Address: JASON PAUL DEMONT, DEMONT & BREYER LLC, PO BOX 7490, SHREWSBURY, NJ, 07702, US

(21) Appl. No.: 09/126,989

(22) Filed: Jul. 31, 1998

(51) Int. Cl. H04M 1/66

(52) U.S. Cl. 455/411

(57) ABSTRACT

A technique for enabling an over-the-air functional entity to authenticate itself to a wireless terminal and to provide new parameters to the wireless terminal is disclosed. In accordance with the illustrative embodiment of the present invention, the over-the-air functional entity is primarily responsible for updating the parameters in the wireless terminal. But if the wireless terminal requests evidence of the over-the-air functional entity's authority to provide the new parameters, the wireless terminal's home wireless telecommunications system prepares the appropriate credentials on behalf of the over-the-air functional entity. The over-the-air functional entity then use these credentials for authenticating itself to the wireless terminal. In other words, although the over-the-air functional entity is responsible for updating the parameters, the wireless terminal's home wireless telecommunications system is responsible for assisting the over-the-air functional entity in authenticating itself to the wireless terminal.

An illustrative embodiment comprises the steps of: transmitting a request to update at least one parameter in a wireless terminal; receiving an authentication challenge from the wireless terminal in response to the request; forwarding the authentication challenge to an authentication center that is associated with the wireless terminal; and receiving an authentication response from the authentication center in response to the authentication challenge.

### FIELD OF THE INVENTION

The present invention relates to wireless telecommunications in general, and, more particularly, to a technique for authenticating an over-the-air functional entity to a wireless terminal so that the over-the-air functional entity can update one or more parameters in the wireless terminal.

### BACKGROUND OF THE INVENTION

FIG. 1 depicts a schematic diagram of a portion of a wireless telecommunications system in the prior art, which provides wireless telecommunications service to one or more wireless terminals (e.g., wireless terminals 101-1 and 101-2) that are situated within a geographic region. For the purposes of this specification, a “wireless terminal” is defined as a telecommunications terminal that is either fixed or mobile and that serves as a user's port to a wireless telecommunications system.

A typical wireless telecommunications system comprises: a wireless switching center (e.g., WSC 120), a plurality of base stations (e.g., base stations 103-1 through 103-3), and a wireline for connecting each base station to the wireless switching center (e.g., wirelines 102-1 through 102-3).

A wireless switching center is the heart of a wireless telecommunications system. A wireless switching center is responsible for, among other things, establishing and maintaining a call between a first wireless terminal and a second wireless terminal or, alternatively, between a wireless terminal and a wireline terminal that is accessible via the local and/or long-distance networks.

Each base station comprises the radios and antennas that the wireless telecommunications system uses to communicate with a wireless terminal and the transmission equipment that the base station uses to communicate with the wireless switching center. The base stations are dispersed throughout the geographic region serviced by the wireless telecommunications system and each base station is responsible for communicating with those wireless terminals that are in the vicinity around it. This vicinity is called a “cell.” As depicted in FIG. 1, each cell is schematically represented by a hexagon. In practice, however, each cell has an irregular shape that depends on the topography of the terrain surrounding the base station.

Each wireless terminal comprises circuitry (e.g., one or more radios, etc.) that enables it to give a user access to the wireless telecommunications system. Typically, the circuitry relies on a variety of parameters to guide it in operating under a variety of conditions. For example, one or more parameters may indicate which radio frequencies a wireless terminal should use under a given circumstance. Occasionally, some or all of the parameters in a wireless terminal need to be updated. There are two fundamentally different techniques for accomplishing this.

In accordance with the first technique, the user of a wireless terminal takes it to an authorized service center where the new parameters are entered into the wireless terminal. Typically, the new parameters are entered manually by a authorized service technician through the wireless terminal's keypad. This is known as “manual service provisioning.”

Manual service provisioning is disadvantageous for several reasons. First, it creates a nuisance for the user who must make the effort and take the time to take the wireless terminal to the service center. Second, it effectively limits how often the parameters can be updated because no user is willing to take his or her wireless terminal to a service center too frequently. Third, the immediacy with which the user can take the wireless terminal to the service center effectively limits how quickly the parameters can be updated, and fourth, if someone other than the user takes the wireless terminal to the service center, the user is deprived of the use of the wireless terminal while it is being serviced. Although manual service provisioning has clear disadvantages, it is the method that has been used most often in the past.

In contrast, the second technique does not require that the wireless terminal be taken to a service center to have its parameters updated. Instead, in accordance with the second technique, the parameters in the wireless terminal are transmitted to the wireless terminal via the wireless terminal's own radio. In other words, a call is placed to the wireless terminal itself (in contrast to the user of the wireless terminal) and the new parameters are provided to the wireless terminal over-the-air. This is known as “over-the-air service provisioning.”

Typically, over-the-air service provisioning is accomplished without the user of the wireless terminal ever being aware that it is being done, and, therefore, it is advantageous over manual service provisioning for several reasons. First, the parameters in the wireless terminal can be updated without inconveniencing the user or depriving the user of the use of the wireless terminal. Second, the parameters can be updated as often as necessary or desirable, and third, the parameters can be updated as quickly as necessary or desirable. For these reasons, over-the-air service provisioning is increasingly favored over manual service provisioning.

There is, however, a significant disadvantage to over-the-air service provisioning. Because the new parameters are provided to the wireless terminal via radio, the possibility exists that an imposter could also update the parameters. An imposter might do this for several reasons.

First, an imposter might desire to sabotage the apparent effectiveness of the wireless terminal, which would incline the user to abandon his or her current service provider and seek service from a competitor. Second, an imposter might update the parameters in the wireless terminal to switch the user to a competing service provider—practice colloquially known as “slamming.” And third, an imposter might update the parameters in a wireless terminal for malicious or mischievous reasons.

Therefore, although over-the-air service provisioning has its advantages, it is well understood that to be practical over-the-air service provisioning must incorporate a mechanism that prevents an imposter from updating the parameters in a wireless terminal. In other words, before over-the-air service provisioning can be considered reliable, a wireless terminal must be capable of determining that the entity that presents new parameters to it is authentic and not an imposter.

The process whereby one entity (e.g., the wireless telecommunications system) evinces its identity to another (e.g., the wireless terminal) is called “authentication.” There are many techniques for authentication that are well-known in the art. In accordance with some of them, both the wireless terminal and the wireless telecommunications system share a secret, s, which is analogous to a computer password or a personal identification number (“PIN”) used for automated banking. Typically, the secret is created by the operator of the wireless telecommunications system. Thereafter, the operator programs the secret, s, into the memory of the wireless terminal and into a home location register (e.g., HLR 111 in FIG. 1) that is associated with the wireless telecommunications system.

When both the wireless terminal and the wireless telecommunications system share a secret, there are two techniques available for authenticating the wireless telecommunications system to the wireless terminal: (1) explicit authentication, and (2) implicit authentication.

In accordance with explicit authentication, the wireless telecommunications system presents some credential (e.g., the secret) to the wireless terminal that the wireless terminal knows could only be produced by the wireless telecommunications system.

Although the wireless telecommunications system could merely present the secret, s, as an indication of its authenticity, in the same manner that computer passwords and PIN numbers are used, this is generally deemed to be unsatisfactory because this enables an eavesdropper to learn the secret, s, and, thereafter, use it to impersonate the wireless telecommunications system. Therefore, an improvement in explicit authentication transmits not the secret, s, itself but rather a deterministic function of the secret that changes every time it is transmitted. If the secret, s, is difficult or impossible to ascertain from the deterministic function of the secret, then an eavesdropper who overhears the function of the secret will be thwarted from computing the secret, s, and from impersonating the wireless telecommunications system. This concept will be elaborated on below.

A well-known technique in the prior art for transmitting an ever-changing function of the secret, s, is known as “challenge-response.” FIG. 2 illustrates a flowchart of the steps that a wireless telecommunications system and a wireless terminal perform to authenticate a wireless telecommunications system to a wireless terminal using challenge-response.

Prior to step 201, both the wireless telecommunications system and the wireless terminal are provided with a secret, s, and a function, ƒ(s,x), that is a function of both the secret and another number, x, which is known as an “authentication challenge.” For example, let s=53,341 and ƒ(x, s)=(x²+s) mod 17

where a mod b is the modulus (a.k.a. remainder) function (e.g., 13,121 mod 37=23).

At step 201, the wireless telecommunications system transmits a request to the wireless terminal indicating that it desires to update the parameters in the wireless terminal.

At step 202, the wireless terminal generates a random authentication challenge (i.e., a random number), x, and transmits it to the wireless telecommunications system. By generating a different authentication challenge, x, each time in step 202, the wireless terminal ensures that the indication of the secret, s, to be received from the wireless telecommunications system in step 203 will also change each time it is transmitted. This eliminates its utility to an eavesdropper. For example, let x=413.

Also at step 202, the wireless terminal evaluates the function, ƒ(s, x), using the authentication challenge, x, and the secret, s, as parameters. For example, ƒ(s, x)=3 for s=53,341 and x=413.

At step 203, a part of the wireless telecommunications system called the authentication center (e.g., AC 112) receives the authentication challenge, x, from the wireless terminal and retrieves the secret, s, from the home location register (e.g., HLR 111). The authentication center then evaluates the function, ƒ(s, x), to generate the authentication response, r. Because the authentication center uses the same values for s and x as does the wireless terminal, the result of the function is the same. For example, r=ƒ(s, x)=3 for s=53,341 and x=413. The authentication response, r=3, is then transmitted by the wireless telecommunications center back to the wireless terminal.

At step 204, the wireless terminal compares the authentication response, r, to the value it derived from the function, ƒ(s, x). If the two values match, then the wireless terminal can reasonably conclude that the other entity is authentic and not an imposter. In such a case, the wireless terminal transmits a validation response to the wireless telecommunications system indicating that it is authenticated and that it can begin transmitting the new parameters.

In contrast, if the two values do not match, then the wireless terminal can reasonably conclude that the entity attempting to provide it with new parameters is an imposter and the process ceases.

At step 205, the wireless telecommunications system transmits one or more parameters to the wireless terminal, which are incorporated by the wireless terminal into its memory. At this point, the process of updating the parameters is complete.

Although the challenge-response protocol can appear burdensome or unnecessarily complex, its utility is clear because even if an eavesdropper overhears the authentication challenge, x=413, and the authentication response, r=3, it will be difficult for the eavesdropper to determine the secret, s, even if the eavesdropper knows the function, ƒ(s, x).

In contrast with the explicit authentication technique of challenge-response, implicit authentication also hinders an imposter from impersonating the wireless telecommunications system. Furthermore, implicit authentication is mechanically more simple than explicit authentication although the theory underlying implicit authentication is more subtle than that underlying explicit authentication.

In accordance with implicit authentication, the wireless telecommunication system encrypts the new parameters themselves with the secret as the cryptographic key. The encrypted parameters are then transmitted to the wireless terminal. Thereafter, the wireless terminal attempts to decrypt the encrypted parameters using the secret as the cryptographic key. If the decrypted parameters have an acceptable syntax, then the wireless terminal can reasonably infer that the new parameters are not from an imposter-the theory being that it is improbable that an imposter could encrypt the parameters without the secret.

Although implicit authentication provides a technically satisfactory solution to the problem of authentication, it is disfavored by regulatory authorities because it requires the wireless transmission of encrypted parameters. Nevertheless, both explicit and implicit authentication provide an acceptable mechanism for authentication.

In the above discussion, the wireless terminal is in direct communication with only one wireless telecommunications system. This greatly simplifies over-the-air service provisioning. In practice, however, there are three facts which complicate over-the-air service provisioning.

(1) A Wireless Terminal Can Be Serviced By Any of Several Wireless Telecommunications Systems—The mobility offered by a wireless terminal enables it to communicate with different wireless telecommunications systems in different regions. For example, the geographic region served by a single wireless telecommunications system can be as large as several thousand square miles, which is about the size of the State of Delaware. Therefore, a vast area, such as the continental United States, can only be served by many systems. As a wireless terminal moves from region to region it is serviced by different systems. Over-the-air service provisioning must be capable regardless of which wireless telecommunications system is currently serving a wireless terminal.

(2) Each Wireless Telecommunications System Is Owned And Operated By One Of A Number of Competing Wireless Service Providers—In the United States each wireless telecommunications system is owned and operated by one of a number of competing wireless service providers (e.g., AT&T, Bell Atlantic, PacTel, Sprint, OmniPoint, etc.). Therefore, as a wireless terminal moves from region to region it is often serviced by a system that is owned by a different service provider than that which owns its home system. This complicates over-the-air service provisioning because the wireless service provider needs to be capable of securely updating the parameters in a wireless terminal even when the wireless terminal is roaming and currently being serviced by a competitor.

(3) The Use of Over-The-Air Functional Entities—Some wireless service providers prefer not to perform the over-the-air service provisioning of their user's wireless terminals themselves. Instead, they prefer to use a proxy known as an “over-the-air functional entity.” FIG. 3 depicts a block diagram of an over-the-air functional entity that is interconnected to a plurality of wireless telecommunications systems via the local and- long-distance networks. The over-the-air functional entity is responsible for updating the parameters in a wireless terminal regardless of where the wireless terminal is, which wireless telecommunications system is serving it, and whether the operator of the serving system is a competitor of the operator of the home system.

Furthermore, because the over-the-air functional entity is not operated by the wireless service providers themselves, they are loath to provide it with the secrets, s, it needs to authenticate itself to the wireless terminals. And without possession of the secrets, s, the over-the-air functional entity cannot authenticate itself to the wireless terminal.

Therefore, the need exists for a technique that allows an over-the-air functional entity to authenticate itself to a wireless terminal: (1) regardless of which wireless telecommunications system is serving it, (2) regardless of whether the operator of the serving system is a competitor to the operator of the home system, and (3) without requiring the home wireless telecommunications system to divulge the secret, s, to the over-the-air functional entity.

### SUMMARY OF THE INVENTION

Some embodiments of the present invention enable an over-the-air functional entity to authenticate itself to a wireless terminal and to provide new parameters to the wireless terminal. Some embodiments of the present invention function: (1) regardless of which wireless telecommunications system is serving it, (2) regardless of whether the operator of the serving system is a competitor to the operator of the home system, and (3) without requiring the home system to divulge any secrets to the over-the-air functional entity. This is advantageous because it provides a mechanism for updating the parameters in a wireless terminal quickly, frequently, without creating a nuisance for the user of the wireless terminal, and without permitting an imposter to update the parameters.

In accordance with the illustrative embodiment of the present invention, the over-the-air functional entity is primarily responsible for updating the parameters in the wireless terminal. But when the wireless terminal requests evidence of the over-the-air functional entity's authority to provide the new parameters, the wireless terminal's home wireless telecommunications system prepares the appropriate credentials on behalf of the over-the-air functional entity. The over-the-air functional entity then use these credentials for authenticating itself to the wireless terminal. In other words, although the over-the-air functional entity is responsible for updating the parameters, the wireless telecommunications system is responsible for assisting the over-the-air functional entity in authenticating itself to the wireless terminal.

This bifurcating of the updating and authentication functions is advantageous for several reasons. First, by preparing the credentials itself, the home wireless telecommunications system never needs to divulge secrets. Second, by preparing the credentials itself, the home wireless telecommunications system can withhold the credentials from the over-the-air functional entity at any time, if at any time that becomes necessary or desirable. Third, by enabling the over-the-air functional entity to present the credentials to the wireless terminal, the wireless terminal can require authentication of the over-the-air functional entity and, thus, thwart imposters from providing it with bogus parameters

The illustrative embodiment comprises the steps of: transmitting a request to update at least one parameter in a wireless terminal; receiving an authentication challenge from the wireless terminal in response to the request; forwarding the authentication challenge to an authentication center that is associated with the wireless terminal; and receiving an authentication response from the authentication center in response to the authentication challenge.

### BRIEF DESCRIPTION OF THE DRAWINGS

FIG. 1 depicts a schematic diagram of a wireless telecommunications system in the prior art.

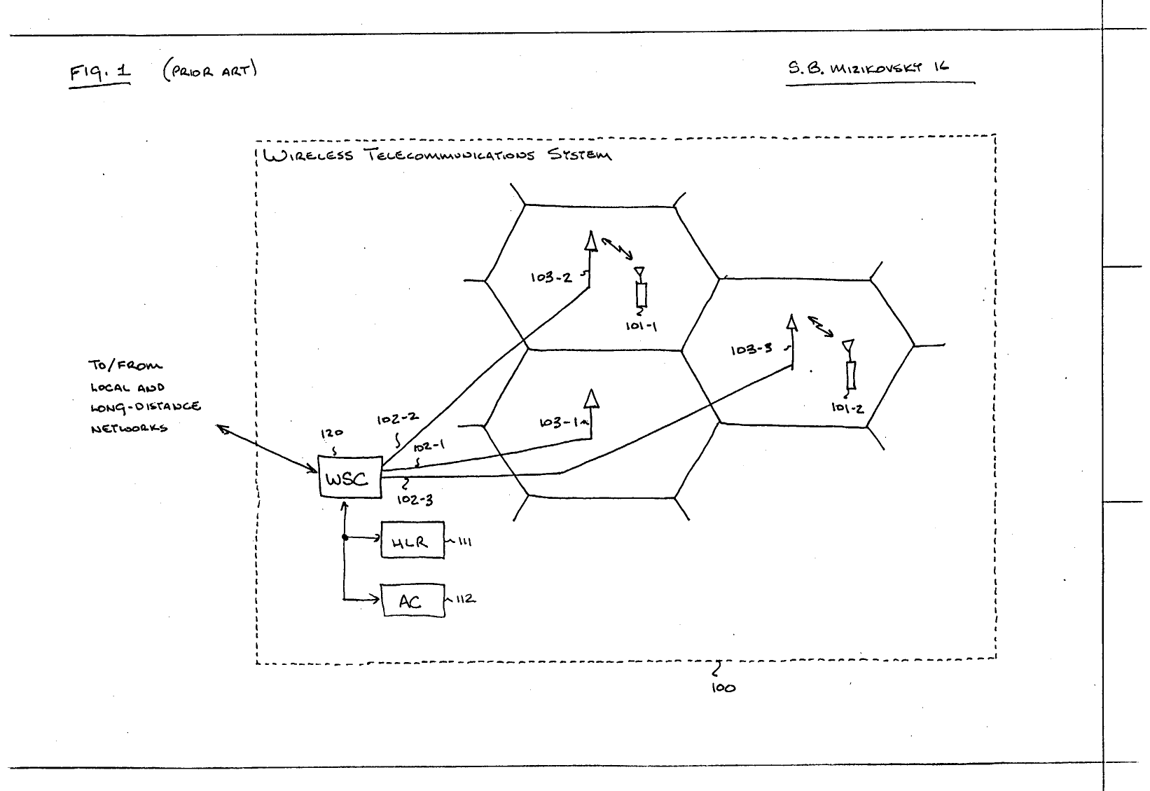

FIG. 2 depicts a flow diagram of the steps involved in over-the-air service provisioning in the prior art.

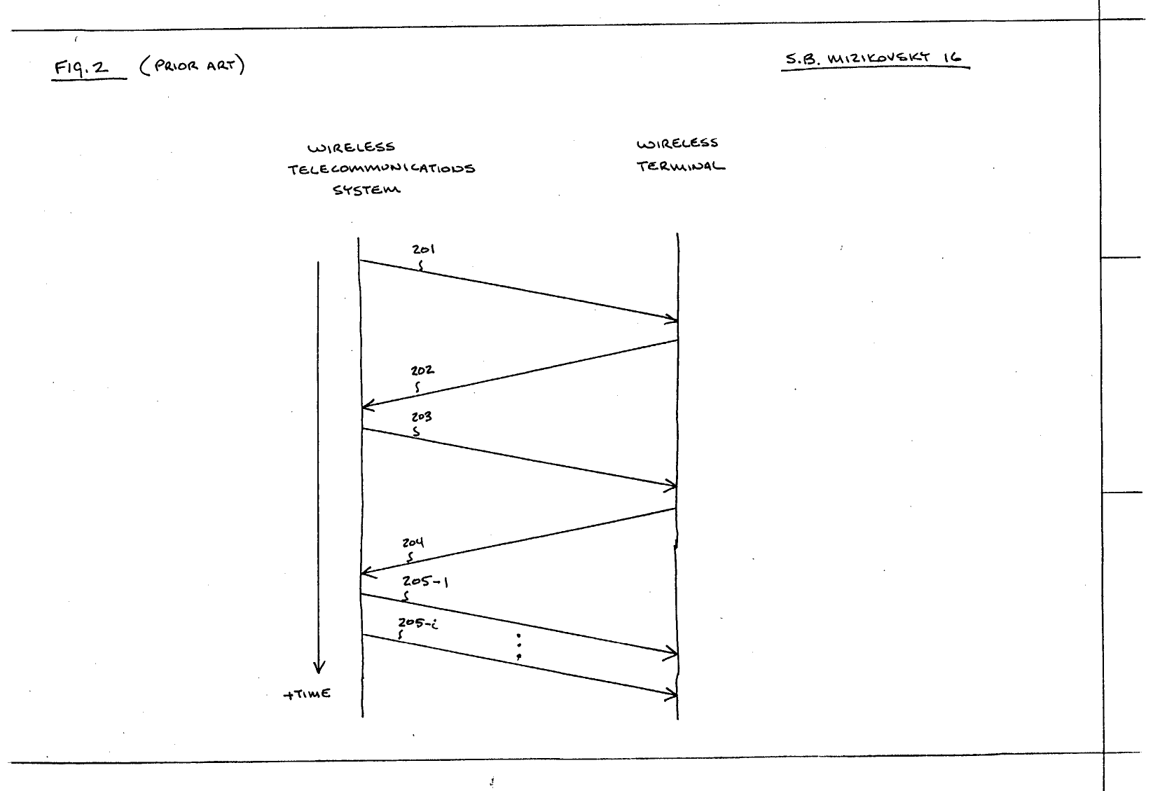

FIG. 3 depicts a schematic diagram of an Over-the-Air functional entity that is interconnected with a plurality of wireless telecommunications systems.

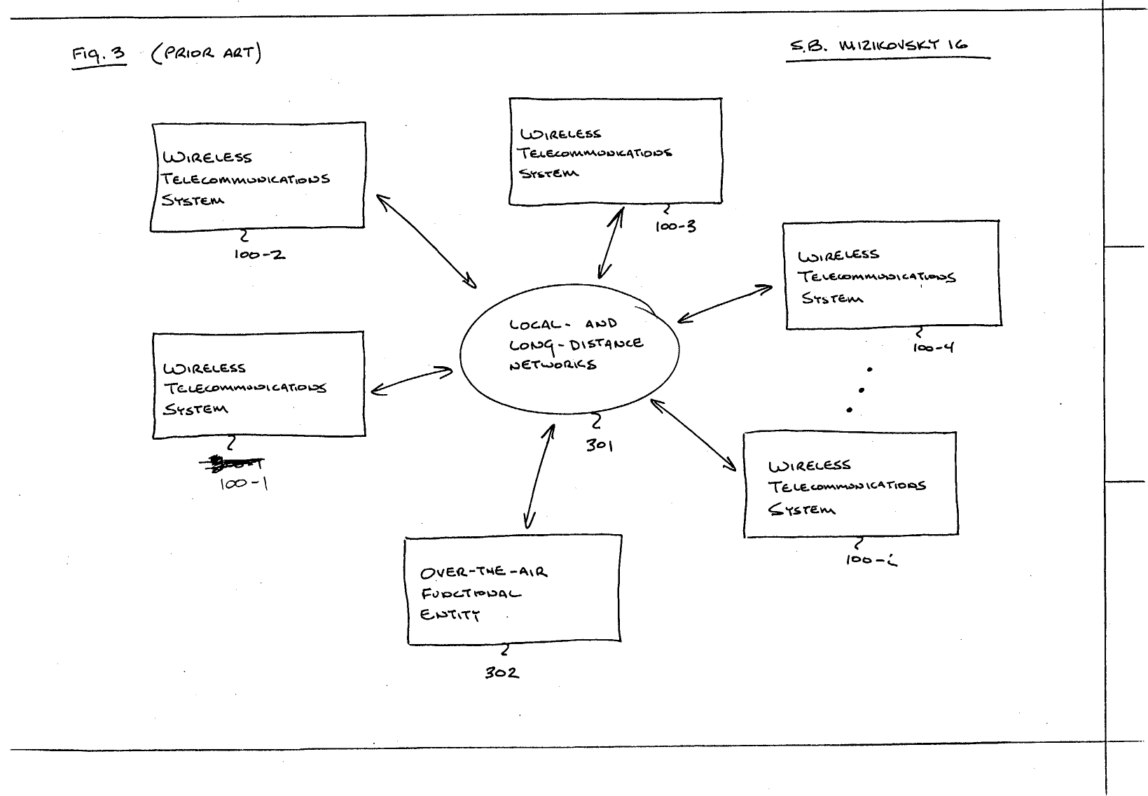

FIG. 4 depicts a block diagram of the illustrative embodiment of the present invention.

FIG. 5 depicts a flowchart of the operation of the illustrative embodiment of the present invention.

### DETAILED DESCRIPTION

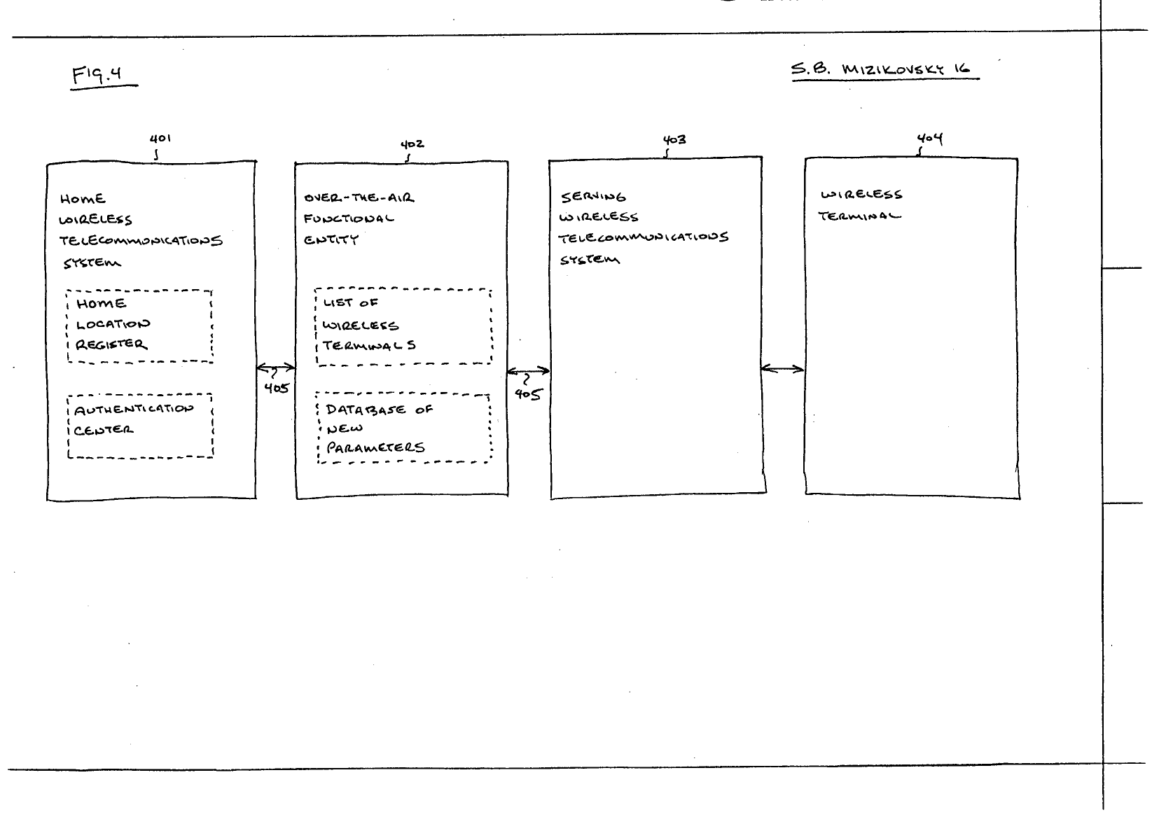

FIG. 4 depicts a block diagram of the illustrative embodiment of the present invention, which comprises: home wireless telecommunications system 401, over-the-air functional entity 402, serving wireless telecommunications system 403, and wireless terminal 404, interconnected as shown.

Home wireless telecommunications system 401 is a wireless telecommunications system, as is well-known in the art, and comprises a home location register and an authentication center. Home wireless telecommunications system 401, the home location register and the authentication center within home wireless telecommunications system 401 are associated with wireless terminal 404 by virtue of the fact that home wireless telecommunications system 401 is the home for wireless terminal 404. Home wireless telecommunications system 401 is capable of communicating with over-the-air functional entity 402 via network 405, in well-known fashion.

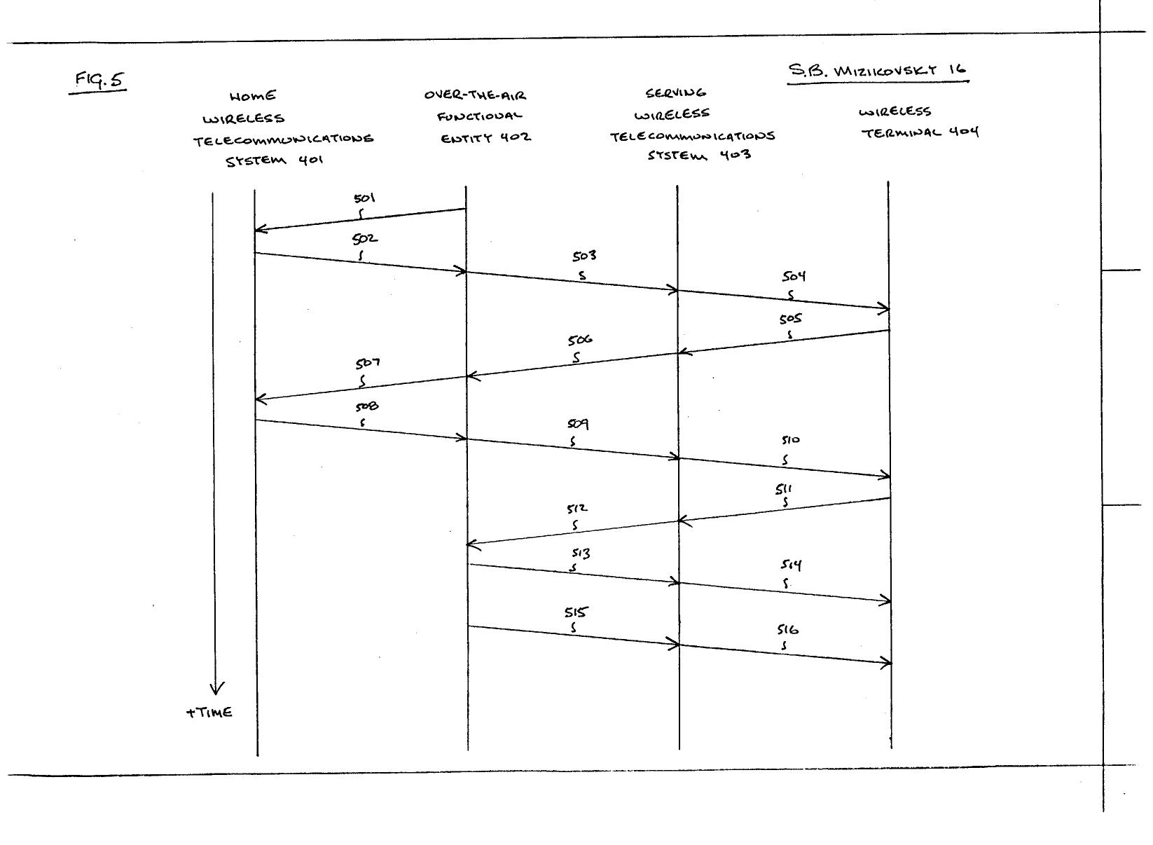

Over-the-air functional entity 402 is advantageously a general-purpose computer that is capable of performing the germane steps depicted in FIG. 5 and described below. Over-the-air functional entity 402 advantageously comprises: (1) a list of the wireless terminals, including wireless terminal 404, whose parameters are to be updated, and (2) a database of the new parameters to be incorporated into those wireless terminals. Furthermore, over-the-air functional entity 402 knows that home wireless telecommunications system 401 is the home for wireless terminal 404 and, therefore, that wireless terminal 404 is associated with home wireless telecommunications system 401. Over-the-air functional entity 402 is advantageously capable of communicating with both home wireless telecommunications system 401 and serving wireless telecommunications system 403 via network 405 and with wireless terminal 404 via serving wireless telecommunications system 403.

Serving wireless telecommunications system 403 is a wireless telecommunications system, as is well-known in the art. The geographic region served by serving wireless telecommunications system 403 can be adjacent to, or overlap, or distinct from the geographic region served by home wireless telecommunications system 401. Furthermore, serving wireless telecommunications system 403 can be operated by the same or a different entity than that which operates home wireless telecommunications system 401. Serving wireless telecommunications system 403 is capable of communicating directly with wireless terminal 404 and with over-the-air functional entity 402 via network 405.

Wireless terminal 404 is capable of communicating directly with serving wireless telecommunications system 403 and indirectly with over-the-air functional entity 402 and home wireless telecommunications system 401 via serving wireless telecommunications system 403. Wireless terminal 404 contains a secret, s, that is also contained within the home location register in home wireless telecommunications system 401 and that is associated with wireless terminal 404. Wireless terminal 404 is advantageously capable of performing the germane steps depicted in FIG. 5 and described below.

FIG. 5 depicts a flowchart of the operation of the illustrative embodiment of the present invention, which enables over-the-air functional entity 402 to authenticate itself to wireless terminal 404 and to update one or more parameters in wireless terminal 404.

Prior to step 501, over-the-air functional entity 402 does not know where wireless terminal 404 is or which wireless telecommunications system is serving it. Therefore, at step 501, over-the-air functional entity 402 begins the process of updating the parameters in wireless terminal 404 by transmitting an inquiry to the home location register in home wireless telecommunications system 401 for the identity of the wireless telecommunications system that is currently serving wireless terminal 404. The home location register in home wireless telecommunications system 401 receives the inquiry.

At step 502, the home location register in home wireless telecommunications system 401 transmits an identifier of serving wireless telecommunications system 403 back to over-the-air functional entity 402. Over-the-air functional entity 402 receives the identifier.

With the knowledge that serving wireless telecommunications system 403 is currently serving wireless terminal 404, at step 503, over-the-air functional entity 402 transmits a request to update at least one parameter in wireless terminal 404 to serving wireless telecommunications system 403 for delivery to wireless terminal 404. Serving wireless telecommunications system 403 receives the request.

At step 504, serving wireless telecommunications system 403 delivers the request to update at least one parameter to wireless terminal 404. Wireless terminal 404 receives that request.

At step 505, wireless terminal 404 generates an authentication challenge, x, and evaluates a function, ƒ(s, x), based on the authentication challenge, x, and secret, s. It will be clear to those skilled in the art that the function, ƒ(s, x), can be based on other parameters as well. Wireless terminal 404 transmits the authentication challenge, x, to serving wireless telecommunications system 403 for delivery to over-the-air functional entity 402. Serving wireless telecommunications system 403 receives the authentication challenge, x.

At step 506, serving wireless telecommunications system 403 delivers the authentication challenge, x, to over-the-air functional entity 402, and, therefore, over-the-air functional entity 402 receives the authentication challenge, x, in response to the request to update at least one parameter in wireless terminal 404.

Because over-the-air functional entity 402 does not have the secret, s, and because home wireless telecommunications system 401 will not divulge the secret, s, over-the-air functional entity 402 can not itself generate the authentication response, r. Therefore, over-the-air functional entity 402 must enlist the assistance of the authentication center in home wireless telecommunications system 401 to generate the authentication response, r. To accomplish this, at step 507, over-the-air functional entity 402 forwards the authentication challenge, x, to the authentication center in home wireless telecommunications system 401. The authentication center receives the authentication challenge, x.

At step 508, the authentication center retrieves the secret, s, from the home location register and evaluates the function, ƒ(s, x), based on the authentication challenge, x, and the secret, s, to generate the authentication response, r, which serves as the credential that over-the-air functional entity 402 will use to evince its authenticity to wireless terminal 404. The authentication center transmits the authentication response, r, to over-the-air functional entity 402. Therefore, over-the-air functional entity 402 receives the authentication response, r, from the authentication center in response to the transmittal of the authentication challenge, x.

At step 509, over-the-air functional entity 402 forwards the authentication response, r, to serving wireless telecommunications system 403 for delivery to wireless terminal 404. Serving wireless telecommunications system 403 receives the authentication response, r.

At step 510, serving wireless telecommunications system 403 delivers the authentication response, r, to wireless terminal 404 and wireless terminal receives it.

At step 511, wireless terminal 404 compares the value it generated in step 505 to the authentication response, r, just received. If the two values match, then wireless terminal 404 concludes that over-the-air functional entity 402 is not an imposter and is authorized to provide it with new parameters. In such case, as part of step 511, wireless terminal 404 transmits a validation response to serving wireless telecommunications system 403 for delivery to over-the-air functional entity 402. This validation response indicates that over-the-air functional entity can begin transmitting one or more new parameters to wireless terminal 404.

In contrast, if the two values do not match, then wireless terminal 404 concludes that the entity transmitting the authentication response, r, is an imposter, in which case the process ceases and wireless terminal 404 does not transmit a validation response.

At step 512, serving wireless telecommunications system 403 forwards the validation response to over-the-air functional entity 402. Over-the-air functional entity 402 therefore receives the validation response in response to the transmittal of the authentication response, r.

In response to the receipt of the validation response, at step 513, over-the-air functional entity 402 transmits at least one parameter to serving wireless telecommunications system 403 for delivery to wireless terminal 513. Serving wireless telecommunications system 403 receives the parameter(s).

At step 514, serving wireless telecommunications system 403 delivers the parameter(s) to wireless terminal 404 and wireless terminal 404 receives and incorporates the new parameter(s) into its memory.

When over-the-air functional entity 402 is finished transmitting new parameters to wireless terminal 404, it transmits a termination message to wireless terminal 404 directing wireless terminal 404 not to accept any new parameters without again going through steps 505 through 511. The termination message is transmitted by over-the-air functional entity 402 to serving wireless telecommunications system 403 for delivery to wireless terminal 513 at step 515.

At step 516, serving wireless telecommunications system 403 provides the termination message to wireless terminal 404, which receives the message. Thereafter, wireless terminal 404 effectively locks itself against future new parameters without first requiring a valid authentication response, r, as generated in steps 505 through 511.

It is to be understood that the above-described embodiments are merely illustrative of the invention and that many variations may be devised by those skilled in the art without departing from the scope of the invention. It is therefore intended that such variations be included within the scope of the following claims and their equivalents.

What is claimed is:

1. A method comprising:
transmitting a request to update at least one parameter in a wireless terminal;
receiving an authentication challenge from said wireless terminal in response to said request;
forwarding said authentication challenge to an authentication center that is associated with said wireless terminal; and
receiving an authentication response from said authentication center in response to said authentication challenge.

2. The method of claim 1 further comprising forwarding said authentication response to said wireless terminal.

3. The method of claim 2 further comprising receiving a validation response message from said wireless terminal in response to said authentication response.

4. The method of claim 3 further comprising transmitting said at least one parameter to said wireless terminal in response to said validation response message.

5. The method of claim 1 further comprising:
transmitting an inquiry to a home location register that is associated with said wireless terminal for an identifier of a wireless telecommunications system currently servicing said wireless terminal;
receiving said identifier; and
transmitting said request to update said at least one parameter to said wireless telecommunications system associated with said identifier.

6. A method comprising:
transmitting an inquiry to a home location register that is associated with a wireless terminal for an identifier of a wireless telecommunications system currently servicing said wireless terminal;
receiving said identifier;
transmitting a request to update at least one parameter to said wireless telecommunications system associated with said identifier;
receiving an authentication challenge from said wireless terminal in response to said request; and
forwarding said authentication challenge to an authentication center that is associated with said wireless terminal.

7. The method of claim 6 further comprising receiving an authentication response from said authentication center in response to said authentication challenge.

8. The method of claim 7 further comprising forwarding said authentication response to said wireless terminal.

9. The method of claim 8 further comprising receiving a validation response message from said wireless terminal in response to said authentication response.

10. The method of claim 9 further comprising transmitting said at least one parameter to said wireless terminal in response to said validation response message.

11. A method comprising:
transmitting a request to update at least one parameter in a wireless terminal;
receiving an authentication challenge from said wireless terminal in response to said request; and
forwarding said authentication challenge to an authentication center that is associated with said wireless terminal.

12. The method of claim 11 further comprising:
receiving an authentication response from said authentication center in response to said authentication challenge; and
forwarding said authentication response to said wireless terminal.

13. The method of claim 12 further comprising receiving a validation response message from said wireless terminal in response to said authentication response.

14. The method of claim 13 further comprising transmitting said at least one parameter to said wireless terminal in response to said validation response message.

15. The method of claim 11 further comprising:
transmitting an inquiry to a home location register that is associated with said wireless terminal for an identifier of a wireless telecommunications system currently servicing said wireless terminal;
receiving said identifier, and
transmitting said request to update said at least one parameter to said wireless telecommunications system associated with said identifier.
